(19) United States
(12) Patent Application Publication
(10) Pub. No.: US 2026/0230838 A1
(43) Pub. Date: Aug. 6, 2026

(54) SYSTEM AND METHOD FOR IDENTIFYING FAILURES IN A WIRELESS NETWORK

(71) Applicant: JIO PLATFORMS LIMITED, Ahmedabad (IN)

(72) Inventors: Shyam Prabhakar MARDIKAR, Gurgaon (IN); Rajib CHAKRABARTI, Navi Mumbai (IN); Kausik SENGUPTA, Navi Mumbai (IN); Raghurarn VELEGA, Mumbai (IN); Ritesh BAVISI, Mumbai (IN); Rajeev SALUJA, Gurgaon (IN); Rahul JOSHI, Jaipur (IN)

(73) Assignee: JIO PLATFORMS LIMITED, Ahmedabad (IN)

(21) Appl. No.: 19/151,533

(22) PCT Filed: Jan. 31, 2024
(86) PCT No.: PCT/IB2024/050877

§ 371 Date: Jul. 28, 2025

(30) Foreign Application Priority Data
Jan. 31, 2023 (IN) 202321006110

(51) Int. Cl. H04W 16/18; H04L 41/5009; H04W 64/00

(52) U.S. Cl. CPC H04W 16/18; H04L 41/5009; H04W 64/00

(57) ABSTRACT

The present disclosure provides a system (108) and a method for identifying failures in a wireless network. The system (108) receives input data from one or more entities (110). The system (108) extracts a plurality of parameters from the input data. The system (108) correlates the plurality of parameters with data stored in one or more data sources associated with the system (108). The system (108) generates a summary report based on the correlation, and identifies the failures in the wireless network based on the summary report.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to a field of mobile network management, and specifically to a system and a method for identifying and managing failures in a wireless network, i.e., addressing customer complaints and network performance issues in a Long-Term Evolution (LTE), a 4th Generation (4G), or a 5^{th} Generation (5G) network.

### BACKGROUND OF INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Typically, most mobile communication network operations teams identify network nodes having low bandwidth availability, high congestion, and alarms, and manage the network nodes for enhancing user experience. Conventional failure identification systems and methods fail to maintain information on failure factors that causes failure of the network nodes, thereby leading to deteriorated user experience. Further, the conventional systems and methods generalize all types of failures that are found in the network nodes, leading to difficulty in separating which complaint pertains to a High-Speed Interface (HSI) issue, a voice issue, or a coverage issue.

There is, therefore, a need in the art to provide an improved system and a method to identify, segregate, and manage failures in a wireless network by overcoming the deficiencies of the prior art(s).

### OBJECTS OF THE INVENTION

Some of the objects of the present disclosure, which at least one embodiment herein satisfies are listed herein below.

It is an object of the present disclosure to provide a system and a method for identifying, segregating, and managing failures in a wireless network.

It is an object of the present disclosure to provide a system and a method for addressing customer complaints and network performance issues in Long-Term Evolution (LTE), 4^{th} Generation (4G), or 5^{th} Generation (5G) mobile networks.

It is an object of the present disclosure to provide a quick customer complaints solution through automated or proactive actions.

It is an object of the present disclosure to proactively identify issues or complaints received for poor services, and to assign the received complaints to respective resolver groups for faster resolution leading to enhanced customer experience and customer loyalty.

It is an object of the present disclosure to reduce customer complaints and improve efficiency of network nodes.

It is an object of the present disclosure to provide a system and a method to enhance business growth.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for identifying failures in a wireless network. The system includes one or more processors, and a memory operatively coupled to the one or more processors. The memory includes processor-executable instructions, which on execution, cause the one or more processors to receive input data from one or more entities, extract a plurality of parameters from the input data, correlate the plurality of parameters with data stored in one or more data sources associated with the system, generate a summary report based on the correlation, and identify one or more failures in the wireless network based on the summary report.

In an embodiment, the one or more entities may include at least one of a Geographic Information System (GIS), a Network Planning Optimization (NPO) system, and base stations.

In an embodiment, the plurality of parameters may include at least one of a Key Performance Indicator (KPI), a Key Quality Indicator (KQI), latitude information, and longitude information, and wherein the KQI may include at least one of network coverage data, voice data, and High-Speed Interface (HSI) data.

In an embodiment, the memory includes processor-executable instructions, which on execution, may cause the one or more processors to prioritize the one or more failures in the wireless network based on a number of users impacted by each of the one or more failures.

In an embodiment, the one or more failures may pertain to at least one of a network coverage, the HSI, and a user equipment.

In an embodiment, the memory includes processor-executable instructions, which on execution, may cause the one or more processors to segregate the one or more failures pertaining to the network coverage, the HSI, and the user equipment.

In an embodiment, in response to the one or more failures pertaining to the network coverage, the one or more processors may detect one or more latched cells in the wireless network, calculate a distance between a user location and a site location based on the one or more latched cells, determine that the distance between the user location and the site location is beyond a predetermined radius, and identify a poor network coverage location based on the determination.

In an embodiment, in response to the one or more failures pertaining to the HSI, the one or more processors may determine that at least one action is aligned on at least one cell in the wireless network, based on the determination, map the at least one action with an action category comprised in the data stored in the one or more data sources, and identify the one or more failures pertaining to the HSI in response to the mapping.

In an embodiment, in response to the one or more failures pertaining to the user equipment, the one or more processors may determine that a plurality of attributes fails to meet a predefined criterion, and identify the one or more failures pertaining to the user equipment based on the determination.

In an aspect, the present disclosure relates to a method for identifying failures in a wireless network. The method includes receiving, by one or more processors associated with a system, input data from one or more entities. The method includes extracting, by the one or more processors, a plurality of parameters from the input data. The method includes correlating, by the one or more processors, the plurality of parameters with data stored in one or more data sources associated with the system. The method includes generating, by the one or more processors, a summary report based on the correlation. The method includes identifying, by the one or more processors, the one or more failures in the wireless network based on the summary report.

In an embodiment, the method may include prioritizing, by the one or more processors, the one or more failures in the wireless network based on a number of users impacted by each of the one or more failures.

In an embodiment, the one or more failures may pertain to at least one of the network coverage, the HSI, and the user equipment.

In an embodiment, in response to the one or more failures pertaining to the network coverage, the method may include detecting, by the one or more processors, one or more latched cells in the wireless network, calculating, by the one or more processors, a distance between a user location and a site location based on the one or more latched cells, determining, by the one or more processors, that the distance between the user location and the site location is beyond a predetermined radius, and identifying, by the one or more processors, a poor network coverage location based on the determination.

In an embodiment, in response to the one or more failures pertaining to the HSI, the method may include determining, by the one or more processors, that at least one action is aligned on at least one cell in the wireless network, based on the determination, mapping, by the one or more processors, the at least one action with an action category comprised in the data stored in the one or more data sources, and identifying, by the one or more processors, the one or more failures pertaining to the HSI in response to the mapping.

In an embodiment, in response to the one or more failures pertaining to the user equipment, the method may include determining, by the one or more processors, that a plurality of attributes fails to meet predefined criteria, and identifying, by the one or more processors, the one or more failures pertaining to the user equipment based on the determination.

In an aspect, the present disclosure relates to a non-transitory computer-readable medium comprising processor-executable instructions that cause a processor to receive input data from one or more entities, extract a plurality of parameters from the input data, correlate the plurality of parameters with data stored in one or more data sources associated with the system, generate a summary report based on the correlation, and identify one or more failures in the wireless network based on the summary report.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) for implementing a proposed system, in accordance with an embodiment of the present disclosure.

FIG. 2 illustrates an exemplary block diagram (200) of a system for identifying failures in a wireless network, in accordance with an embodiment of the present disclosure.

FIG. 3 illustrates an exemplary architecture (300) of a system for identifying failures in a wireless network, in accordance with embodiments of the present disclosure.

FIG. 4 illustrates an exemplary flow diagram (400) for implementing a method for identifying failures in a wireless network, in accordance with embodiments of the present disclosure.

FIG. 5 illustrates an exemplary computer system (500) in which or with which embodiments of the present disclose may be utilized in accordance with embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a system and a method for identifying failures in a wireless network. The system may be a Root Cause Fix (RCF) system which includes a scorecard to reflect true service experience perceived by each customer in the wireless network. The scorecard may capture important service Key Performance Indicators (KPIs), Key Quality Indicators (KQIs) which include coverage, voice, and High-speed Interface (HSI), and other allied information such as latitude information, longitude information, and planned solutions.

The system may detect and resolve service experience issues faced by the customers in a proactive manner. As such, the KPIs/KQIs and all the information captured in the system may help in identifying customer's satisfaction or dissatisfaction, accurately.

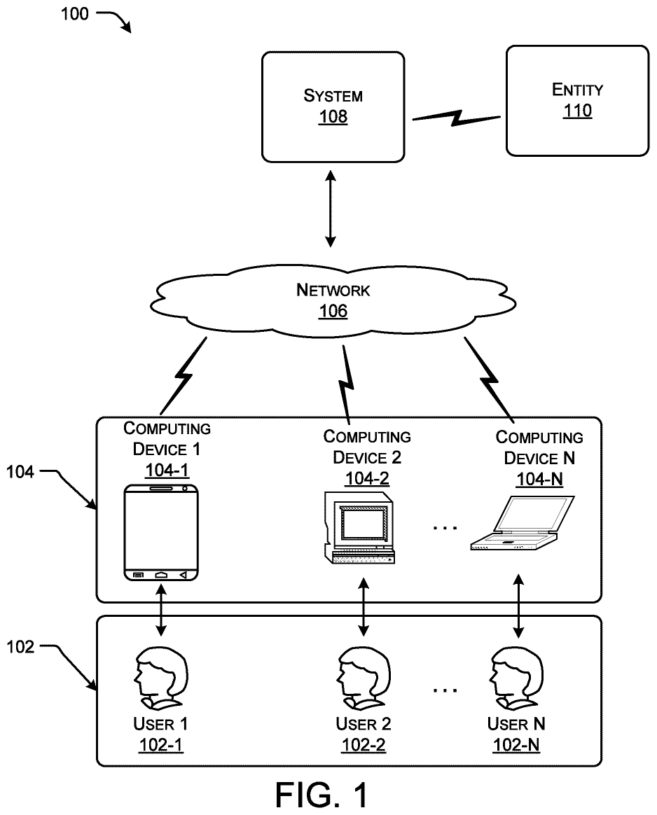

Various embodiments of the present disclosure will be explained in detail with reference to FIGS. 1-5.

FIG. 1 illustrates an exemplary network architecture (100) for implementing a proposed system (108), in accordance with an embodiment of the present disclosure.

As illustrated in FIG. 1, by way of example and not by not limitation, the exemplary network architecture (100) may include a plurality of computing devices (104-1, 104-2 . . . 104-N), which may be individually referred as the computing device (104) and collectively referred as the computing devices (104). The computing devices (104) may be associated with a plurality of users (102-1, 102-2 . . . 102-N). The plurality of users (102-1, 102-2 . . . 102-N) may be individually referred as the user (102) and collectively referred as the users (102).

It may be appreciated that the computing device (104) may be interchangeably referred to as a user device, a client device, or a User Equipment (UE). The plurality of UEs (104) may include, but not be limited to, scanners such as cameras, webcams, scanning units, and the like.

In an embodiment, the UE (104) may include smart devices operating in a smart environment, for example, an Internet of Things (IoT) system. In such an embodiment, the UE (104) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users and/or entities, or any combination thereof.

A person of ordinary skill in the art will appreciate that the computing device, or the user device, or the UE (104) may include, but is not limited to, intelligent, multi-sensing, network-connected devices, that can integrate seamlessly with each other and/or with a central server or a cloud-computing system or any other device that is network-connected.

In an embodiment, the user device or the UE (104) may include, but is not limited to, a handheld wireless communication device (e.g., a mobile phone, a smartphone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the UE (104) may include, but is not limited to, any electrical, electronic, electromechanical, or an equipment, or a combination of one or more of the above devices such as virtual reality (VR) devices, augmented reality (AR) devices, a laptop, a general-purpose computer, a desktop, a personal digital assistant, a tablet computer, a mainframe computer, or any other computing device, wherein the UE (104) may include one or more in-built or externally coupled accessories including, but not limited to, a visual aid device such as a camera, an audio aid, a microphone, a keyboard, and input devices for receiving input from the user or the entity such as a touch pad, a touch enabled screen, an electronic pen, and the like.

A person of ordinary skill in the art will appreciate that the UE (104) may not be restricted to the mentioned devices and various other devices may be used.

In an exemplary embodiment, the UE (104) may communicate with the system (108) through a network (106). The network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof.

In an exemplary embodiment, the system (108) may be associated with a plurality of entities (110), which may be individually referred as the entity (110) and collectively referred as the entities (110). The entities (110) may be, for example, but not limited to, a Geographic Information System (GIS), a Network Planning Optimization (NPO) system, and base stations.

In an exemplary embodiment, the system (108) may be configured to receive input data from the entities (110). The input data may include physical, network, and system software faults and measurements such as, network data, customer data, and device data. The system (108) may be configured to extract a plurality of parameters from the input data. The plurality of parameters may include, but not limited to, a Key Performance Indicator (KPI), a Key Quality Indicator (KQI), latitude information, and longitude information. The KQI may include, but not limited to, network coverage, voice data, and High-Speed Interface (HSI).

In an exemplary embodiment, the system (108) may be configured to correlate the plurality of parameters with data stored in one or more data sources associated with the system (106), and generate a summary report based on the correlation. Further, the system (108) may be configured to identify the failures in the wireless network based on the summary report.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

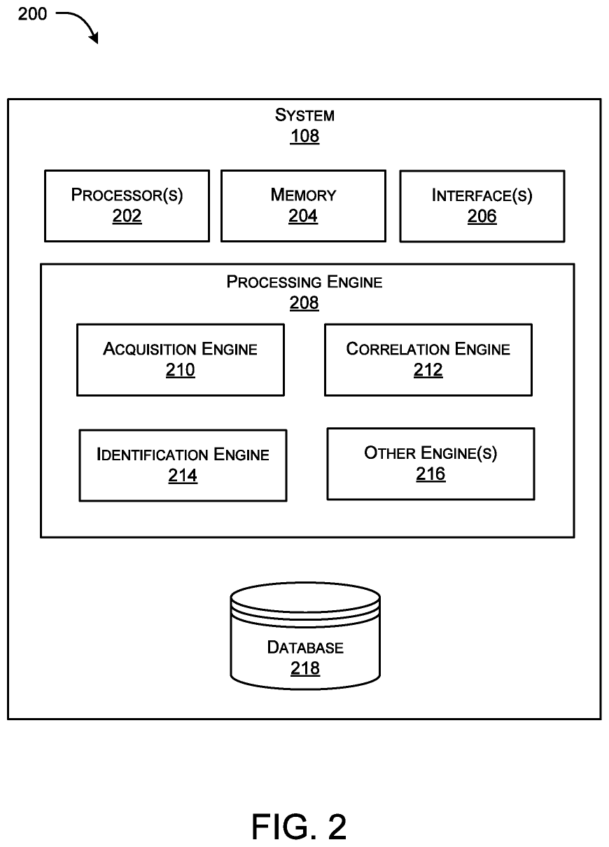

FIG. 2 illustrates an exemplary block diagram (200) of a system (108) for identifying failures in a wireless network, in accordance with an embodiment of the present disclosure.

In an embodiment, and as shown in FIG. 2, the system (108) may include one or more processors (202). The one or more processors (202) may be implemented as one or more microprocessors, microcomputers, microcontrollers, digital signal processors, central processing units, logic circuitries, and/or any devices that manipulate data based on operational instructions. Among other capabilities, the one or more processors (202) may be configured to fetch and execute computer-readable instructions stored in a memory (204) of the system (108). The memory (204) may store one or more computer-readable instructions or routines, which may be fetched and executed to create or share the data units over a network service. The memory (204) may comprise any non-transitory storage device including, for example, volatile memory such as Random-Access Memory (RAM), or non-volatile memory such as an Erasable Programmable Read-Only Memory (EPROM), a flash memory, and the like.

In an embodiment, the system (108) may also include an interface(s) (206). The interface(s) (206) may include a variety of interfaces, for example, a variety of interfaces, for example, interfaces for data input and output devices, referred to as I/O devices, storage devices, and the like. The interface(s) (206) may facilitate communication of the system (108) with various devices coupled to it. The interface(s) (206) may also provide a communication pathway for one or more components of the system (108). Examples of such components include, but are not limited to, processing engine(s) (208) and a database (218).

In an embodiment, the processing engine(s) (208) may be implemented as a combination of hardware and programming (for example, programmable instructions) to implement one or more functionalities of the processing engine(s) (208). In examples, described herein, such combinations of hardware and programming may be implemented in several different ways. For example, the programming for the processing engine(s) (208) may be processor-executable instructions stored on a non-transitory machine-readable storage medium and the hardware for the one or more processors (202) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by an electronic circuitry.

In an embodiment, the database (218) may comprise data that may be either stored or generated as a result of functionalities implemented by any of the components of the processors (202) or the processing engine(s) (208) or the system (108).

In an exemplary embodiment, the processing engine(s) (208) may include one or more engines selected from any of an acquisition engine (210), a correlation engine (212), an identification engine (214), and other units/engines (216). The other units/engines (216) may include, but are not limited to, a monitoring engine, a determination engine, and the like.

In an embodiment, the one or more processors (202) may, via the acquisition engine (210), receive input data from one or more entities (e.g., 110 of FIG. 1). The one or more entities (110) may include, but not limited to, a GIS, a NPO system, and base stations.

In an embodiment, the one or more processors (202) may, via the correlation engine (212), extract a plurality of parameters from the input data. The plurality of parameters may include, but not limited to, a KPI, a KQI, latitude information, and longitude information. The KQI may include, but not limited to, network coverage, voice data, and HSI. In an embodiment, the one or more processors (202) may, via the correlation engine (212), correlate the plurality of parameters with data stored in one or more data sources associated with the system (108).

In an embodiment, the one or more processors (202) may, via the identification engine (214), generate a summary report based on the correlation. In an embodiment, the one or more processors (202) may, via the identification engine (214), identify the failures in the wireless network based on the summary report.

In an embodiment, the one or more processors (202) may, via the identification engine (214), generate a priority report based on the correlation. The one or more processors (202) may prioritize the failures in the wireless network using the priority report. The one or more processors (202) may prioritize the failures based on a number of users (e.g., 102 of FIG. 1) effected by the failures. The failures may pertain to, without limitation, network coverage, HSI, and UE (104).

In an embodiment, the one or more processors (202) may, via the identification engine (214), identify and segregate the failures pertaining to the network coverage, the HSI, and the UE (104) efficiently. In response to the failures pertaining to the network coverage, the one or more processors (202) may detect one or more latched cells in the wireless network. The one or more processors (202) may calculate a distance between a user location and a site location based on the one or more latched cells. The one or more processors (202) may determine that the distance between the user location and the site location is beyond a predetermined radius, and identify a poor network coverage location based on the determination.

For network coverage issues, data may be collected from the data sources, for example, a coverage root cause analytics (RCA), a site details summary, NPO tables, and the like. In response to the failures pertaining to the network coverage, based on the RCA data, the latched cell may be checked and the distance between the user location and the site location may be calculated. Based on a clutter category, if the user is found within the site radius, all actions (e.g., using action codes) for the cell from all bands (e.g., in NPO data) may be checked. Thereafter, respective action categories may be mapped to the RCF data. A poor network coverage location may be identified if the user is found beyond the site radius (e.g., using clutter type and cell radius). Further, the one or more processors (202) may determine if a planned new cell site solution can solve coverage problems of the location, and solve the coverage problems accordingly. If no solution is planned, then a list may be sent to a Network Planning and Engineering (NPE) team for further analysis and planning.

In an embodiment, in response to the failures pertaining to the HSI, the one or more processors (202) may determine if at least one action is aligned on at least one cell in the wireless network. If the at least one action is aligned on the at least one cell in the wireless network, the one or more processors (202) may map the at least one action with an action category included in the data stored in the one or more data sources, and identify the failures pertaining to the HSI based the mapping.

For the HSI related issues, the data sources used may be, for example, HSI RCA, site details summary, NPO tables, and the like. In response to the failures pertaining to the HSI, the one or more processors (202) may determine all actions (Physical Checks, Sector Alignment, Remote Electrical Tilt Checks, Capacity Addition, Band Addition) aligned for the cell from all bands (e.g., in the NPO data), and a respective action category (Network Health, RF, Coverage, Capacity) may be mapped to the actions aligned for the cell. If no action is aligned on the cell by an NPO/BTG funnel, then the action may be sent to the NPE team to check if a sector is qualifying for new solution criteria. The action codes may be, without limitation, as below:
“SE Lmt” action code: For Outdoor Small Cell (OSC), Enhanced Small Cell (ESC) site type, the one or more processors (202) may check if it is found for at least one band, and for the rest of site types. The “SE Lmt” action code may be checked for at least two bands to qualify for BTG capacity.
For FDD band to TDD Band Optimization (FTO)-Both the BTG coverage and Radio Frequency (RF) optimization digital may be mapped.

Further, the one or more processors (202) may determine the BTG solutions for providing a long-term fix solution. Using the cell location, the one or more processors (202) may check if the planned new sites map the cell location to the data stored in the data sources. It must be appreciated that one cell may have more than one BTG mapped.

In an embodiment, in response to the failures pertaining to the UE (104), the one or more processors (202) may determine that a plurality of attributes fails to meet predefined criteria, and identify the failures pertaining to the UE (104) based on the determination. The plurality of attributes may include, but not limited to, Robust Header Compression (ROHC) factors, voice issues defined in the band cell, backhaul issues, self-outages and/or neighbor outages, optimization actions, and the like.

For the voice related issues or the failures pertaining to the UE (104), the data sources used may be, for example, voice RCA, site details summary, NPO tables, and the like. During the voice related issues or the failures pertaining to the UE (104), the following criterion may be checked:

Case 1:
Check if {ROHC contributes to be greater than 70% of the factors}
Then, alert NPE team - Device related issue (Device flow)
Else, check if {the voice problem is in 2300 band cell if
{cell is in ESC/OSC/Indoor Small Cell (ISC)/Indoor System 1 (IS1)/In
Building Solutions (IBS) AND ‘SE Lmt’ (1) is printed in NPO data: BTG
flow}
Else, if {Backhaul issue: Backhaul - BH (check all 2300 bands)}
Else, if {self and/or neighbour outage: outage - SO, NO (check all 2300
bands)}
Else, check optimization actions and map respective optimization categories
and if optimization action is not found then mark it as “No correlation found.”
Case 2:
Else, if {voice problem is in 1800 band cell if {SE limit (at least 2 bands) is
printed in NPO data: BTG flow}
Else, if {Backhaul issue: Backhaul (check all 1800 bands)}
Else, if {self and/or neighbour outage: outage (check all 1800 bands)}
Else, check optimization actions and map respective optimization categories
and if optimization action not found mark it as “No correlation found.”
Case 3:
Else, check if the {voice problem is in 850 band cell:
if {SE limit (at least 2 bands) is printed in NPO data: BTG flow}
Else if {RSRP issue >20% and/or TA-ISD >20% issue: initiate coverage
RCF}
Else, check optimization actions and map respective optimization categories
and if optimization action not found mark it as “No correlation found”}.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

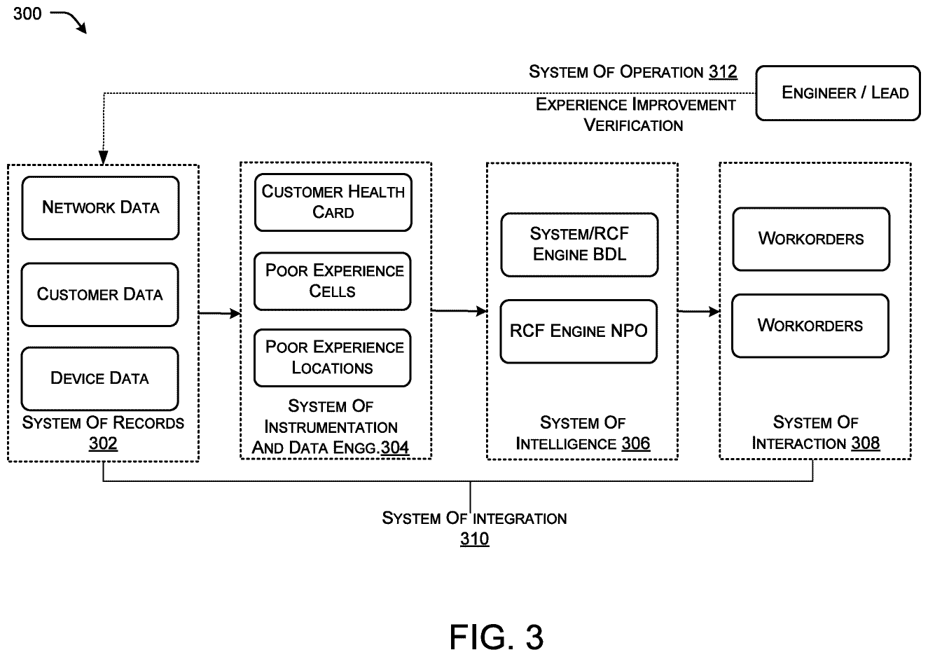

FIG. 3 illustrates an exemplary architecture (300) of a system (108) for identifying failures in a wireless network, in accordance with embodiments of the present disclosure.

With respect to FIG. 3, at step 302, a system of records may be collected from customer data, network data, and device data. Using the system of records, at step 304, a system of instrumentation and data engineering may be determined. The system of instrumentation and data engineering may include, without limitation, a customer health card, poor experience cells, and poor experience locations. At step 306, the customer health card, the poor experience cells, and the poor experience locations may be provided as an input to a system of intelligence. The system of intelligence may include, without limitation, RCF engine Big Data Lake (BDL) and RCF engine NPO. At step 308, the RCF engine BDL and the RCF engine NPO may generate a system of interaction which includes workorders to identify the failures in network nodes. At 310, the systems represented at each of the steps (step 302-step 308) may be combined to form a system of integration. At step 312, results from the system of interaction may be collected by a lead engineer/team lead to control a system of operation for verification of customer experience improvement.

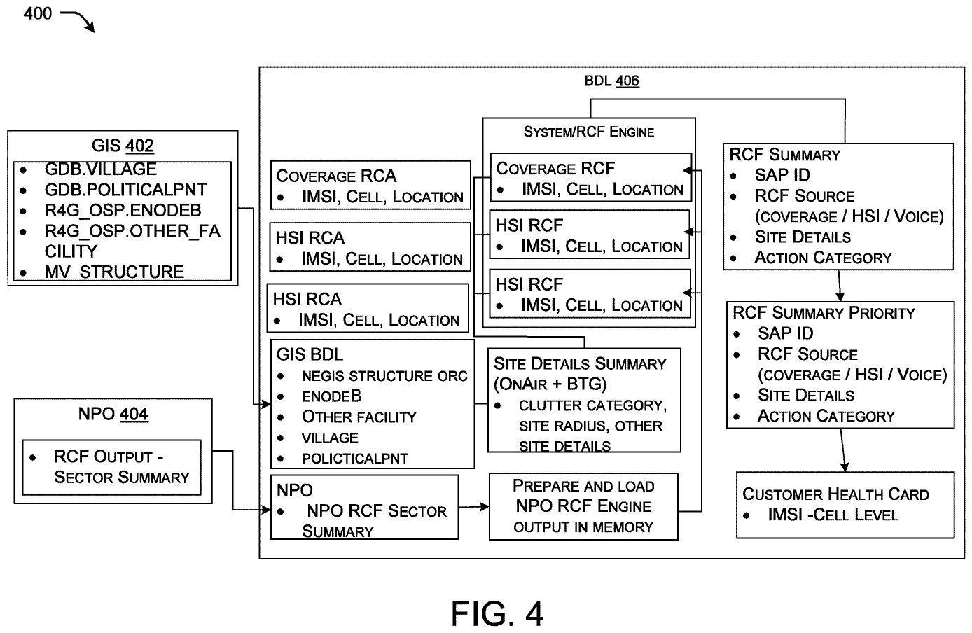

FIG. 4 illustrates an exemplary flow diagram (400) for implementing a method for identifying failures in a wireless network, in accordance with embodiments of the present disclosure.

With respect to FIG. 4, it may be appreciated that the system (108) may be interchangeably referred to as a RCF engine. The RCF engine may receive input from two major sources, i.e., a GIS (402) and a NPO (404). From the GIS (402), selective columns that hold information about village, Evolved Node B (eNodeB), structure details, and other facilities information may be determined. The NPO (404) may deliver a sector summary for linking BDL data with the RCF data, to prepare an optimized result.

The GIS data on the BDL (406) may be combined with data holding information about Live and BTG sites to obtain site details in consideration. Then, this data may be matched with the input that is received from the NPO. Finally, the resultant data may be stored on the BDL (406) in separate tables for the RCF (with respect to the voice profile, the coverage profile, and the HSI profile) which holds data for International Mobile Subscriber Identity (IMSI), cell, and location.

Moreover, to generate a more precise result for fulfilling crucial goals, a RCF summary priority may be determined using a customer health card (CHC) and the RCF summary as inputs and the data Input/Output may run on different applications.

The system (108) may perform a fully automated process in identifying the failures in the wireless network. The system (108) may be operated using dynamic algorithms and may be configured to operate differently using dynamic parameters. The system (108) may provide a modular and scalable solution to manage the issues in the wireless network which reduces manual efforts.

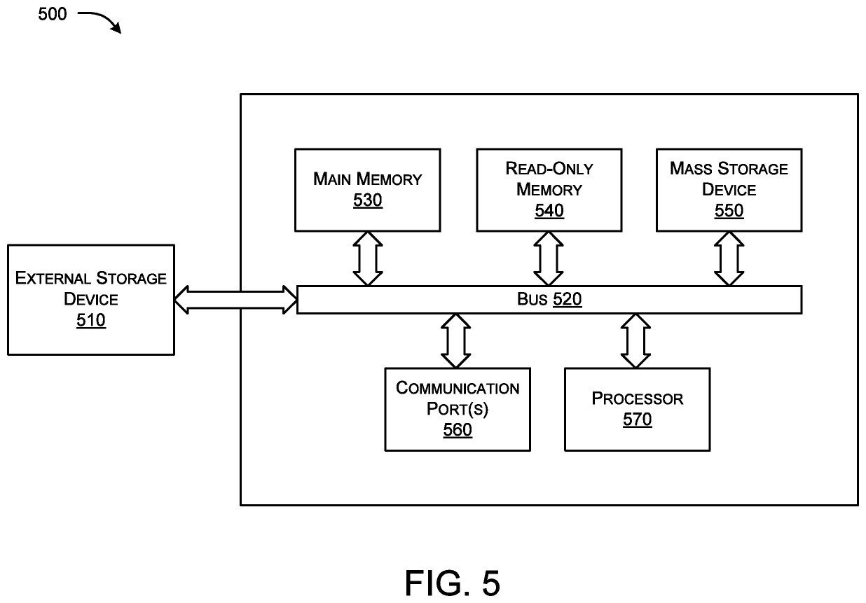

FIG. 5 illustrates an exemplary computer system (500) in which or with which embodiments of the present disclose may be utilized in accordance with embodiments of the present disclosure.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor (570) and communication ports (560). The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system (500) connects.

In an embodiment, the main memory (530) may be a Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (570) with the other memory, storage, and communication blocks. The bus (520) may be, e.g., a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). Components described above are meant only to exemplify various possibilities. In no way should the aforementioned exemplary computer system (500) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method to identify failures in a wireless network efficiently, and automatically addresses customer complaints.

The present disclosure improves customer experience leading to higher customer satisfaction.

The present disclosure reduces customer complaints and improves efficiency of network operations teams through automated and accurate diagnosis of issues.

The present disclosure reduces manual efforts for diagnosis and resolution of issues.

The present disclosure enhances business growth.

We claim:

1. A system (108) for identifying failures in a wireless network, the system (108) comprising:
one or more processors (202); and
a memory (204) operatively coupled to the one or more processors (202), wherein the memory (204) comprises processor-executable instructions, which on execution, cause the one or more processors (202) to:
receive input data from one or more entities;
extract a plurality of parameters from the input data;
correlate the plurality of parameters with data stored in one or more data sources associated with the system (108);
generate a summary report based on the correlation; and
identify one or more failures in the wireless network based on the summary report.

2. The system (108) as claimed in claim 1, wherein the one or more entities comprise at least one of: a Geographic Information System (GIS), a Network Planning Optimization (NPO) system, and base stations.

3. The system (108) as claimed in claim 1, wherein the plurality of parameters comprises at least one of: a Key Performance Indicator (KPI), a Key Quality Indicator (KQI), latitude information, and longitude information, and wherein the KQI comprises at least one of: network coverage data, voice data, and High-Speed Interface (HSI) data.

4. The system (108) as claimed in claim 1, wherein the memory (204) comprises processor-executable instructions, which on execution, cause the one or more processors (202) to prioritize the one or more failures in the wireless network based on a number of users effected by each of the one or more failures.

5. The system (108) as claimed in claim 1, wherein the one or more failures pertain to at least one of: a network coverage, a High-Speed Interface (HSI), and a user equipment.

6. The system (108) as claimed in claim 5, wherein the memory (204) comprises processor-executable instructions, which on execution, cause the one or more processors (202) to segregate the one or more failures pertaining to the network coverage, the HSI, and the user equipment.

7. The system (108) as claimed in claim 5, wherein in response to the one or more failures pertaining to the network coverage, the one or more processors (202) are to:
detect one or more latched cells in the wireless network;
calculate a distance between a user location and a site location based on the one or more latched cells;
determine that the distance between the user location and the site location is beyond a predetermined radius; and
identify a poor network coverage location based on the determination.

8. The system (108) as claimed in claim 5, wherein in response to the one or more failures pertaining to the HSI, the one or more processors (202) are to:
determine that at least one action is aligned on at least one cell in the wireless network;
based on the determination, map the at least one action with an action category comprised in the data stored in the one or more data sources; and
identify the one or more failures pertaining to the HSI based on the mapping.

9. The system (108) as claimed in claim 5, wherein in response to the one or more failures pertaining to the user equipment, the one or more processors (202) are to:
determine that a plurality of attributes fails to meet a predefined criterion; and
identify the one or more failures pertaining to the user equipment based on the determination.

10. A method for identifying failures in a wireless network, the method comprising:
receiving, by one or more processors (202) associated with a system (108), input data from one or more entities;
extracting, by the one or more processors (202), a plurality of parameters from the input data;
correlating, by the one or more processors (202), the plurality of parameters with data stored in one or more data sources associated with the system (108);
generating, by the one or more processors (202), a summary report based on the correlation; and
identifying, by the one or more processors (202), one or more failures in the wireless network based on the summary report.

11. The method as claimed in claim 10, comprising prioritizing, by the one or more processors (202), the one or more failures in the wireless network based on a number of users effected by each of the one or more failures.

12. The method as claimed in claim 10, wherein the one or more failures pertain to at least one of: a network coverage, a High-Speed Interface (HSI), and a user equipment.

13. The method as claimed in claim 12, wherein in response to the one or more failures pertaining to the network coverage, the method comprises:
detecting, by the one or more processors (202), one or more latched cells in the wireless network;
calculating, by the one or more processors (202), a distance between a user location and a site location based on the one or more latched cells;
determining, by the one or more processors (202), that the distance between the user location and the site location is beyond a predetermined radius; and
identifying, by the one or more processors (202), a poor network coverage location based on the determination.

14. The method as claimed in claim 12, wherein in response to the one or more failures pertaining to the HSI, the method comprises:
determining, by the one or more processors (202), that at least one action is aligned on at least one cell in the wireless network;
based on the determination, mapping, by the one or more processors (202), the at least one action with an action category comprised in the data stored in the one or more data sources; and
identifying, by the one or more processors (202), the one or more failures pertaining to the HSI in response to the mapping.

15. The method as claimed in claim 12, wherein in response to the one or more failures pertaining to the user equipment, the method comprises:
determining, by the one or more processors (202), that a plurality of attributes fails to meet predefined criteria; and
identifying, by the one or more processors (202), the one or more failures pertaining to the user equipment based on the determination.

16. A non-transitory computer-readable medium comprising processor-executable instructions that cause a processor to:
receive input data from one or more entities;
extract a plurality of parameters from the input data;
correlate the plurality of parameters with data stored in one or more data sources associated with a system (108);
generate a summary report based on the correlation; and
identify one or more failures in a wireless network based on the summary report.
